(19) United States
(12) Patent Application Publication
(10) Pub. No.: US 2023/0211799 A1
(43) Pub. Date: Jul. 6, 2023

(54) METHOD AND APPARATUS FOR AUTONOMOUS DRIVING CONTROL BASED ON ROAD GRAPHICAL NEURAL NETWORK

(71) Applicant: SEOUL NATIONAL UNIVERSITY R&DB FOUNDATION, Seoul (KR)

(72) Inventors: Taeoh HA, Seoul (KR); Mineui HONG, Seoul (KR); Songhwai OH, Seoul (KR); Gunmin LEE, Seoul (KR); Dohyeong KIM, Seoul (KR)

(21) Appl. No.: 18/090,000

(22) Filed: Dec. 28, 2022

(30) Foreign Application Priority Data
Dec. 30, 2021 (KR) 10-2021-0193529

(51) Int. Cl. B60W 60/00; G06N 3/092; G06N 3/044

(52) U.S. Cl. CPC B60W 60/001; G06N 3/044; G06N 3/092

(57) ABSTRACT

Provided are an autonomous driving control apparatus and method based on a Road-GNN. By using road graph-based data, a network can more accurately and efficiently understand road shape information, and driving performance is improved.

### CROSS-REFERENCE TO RELATED APPLICATION

Pursuant to 35 U.S.C. § 119, this application claims the benefit of earlier filing date and right of priority to Korean Application No. 10-2021-0193529, filed on Dec. 30, 2021, the contents of which are all hereby incorporated by reference herein in their entirety.

### BACKGROUND

### Technical Field

The present invention relates to a method and apparatus for autonomous driving control based on a road graphical neural network (Road-GNN), and more particularly to a method and apparatus for training a neural network using information representing a road in the form of a graph, and controlling autonomous driving using the trained network.

### Description of Related Art

Content to be described below is only provided for the purpose of providing background information related to an embodiment of the present invention, and it is obvious that the content to be described does not constitute the prior art.

Reinforcement learning refers to a method of training a network in a direction of maximizing an expected value of a reward by giving the reward to the network.

Recently, research has been conducted on technology for controlling autonomous vehicles using reinforcement learning. Since such technology mainly uses a position and speed information of a vehicle or 2D map image information of a road, it has been difficult for a network to use road information smoothly and efficiently. For this reason, conventionally, a test has been performed only in a fixed road environment, and application to a new road environment that is different in terms of cost and performance has been difficult.

That is, even though conventional technology has attempted vehicle control using position and speed information of a vehicle or 2D map image information of a road, since it is difficult for a network to understand information such as a road shape, there is a limit in that driving performance is significantly reduced when applied to a new road.

Meanwhile, the above-mentioned conventional technology is technical information possessed by the inventor for derivation of the present invention or acquired in a process of derivation of the present invention, and may not be known technology disclosed to the general public before the filing of the present invention.

### SUMMARY OF THE INVENTION

Therefore, the present invention has been made in view of the above problems, and it is an object of the present invention to provide a method and apparatus for autonomous driving control based on a Road-GNN and reinforcement learning.

The object of the present invention is not limited to the above-mentioned problem, and other objects and advantages of the present invention not mentioned herein may be understood by the following description, and will be more clearly understood by the embodiments of the present invention. Further, it will be appreciated that the objects and advantages of the present invention may be realized by means and combinations thereof indicated in the claims.

In accordance with an aspect of the present invention, the above and other objects can be accomplished by the provision of an autonomous driving control method performed by an autonomous driving control apparatus including a processor, the autonomous driving control method including encoding first feature information associated with a node-edge-level feature of a road graph from node feature information and edge feature information of the road graph using a first encoder based on a multilayer perceptron, encoding second feature information associated with a graph-level feature of the road graph from the first feature information using a second encoder based on a graph neural network (GNN), and encoding third feature information associated with a time-series feature of the road graph from a series of the second feature information using a third encoder based on a recurrent neural network, in which the road graph includes at least one node, each node corresponding to a point on a road, and at least one edge, each edge corresponding to a connection relationship between nodes.

In accordance with another aspect of the present invention, there is provided an autonomous driving control apparatus including a processor, and a memory configured to store a Road-GNN including a first encoder, a second encoder, and a third encoder, and at least one instruction, in which, when executed by the processor, the at least one instruction causes the processor to perform a first operation of encoding first feature information associated with a node-edge-level feature of a road graph from node feature information and edge feature information of the road graph using the first encoder based on the multilayer perceptron, a second operation of encoding second feature information associated with a graph-level feature of the road graph from the first feature information using the second encoder based on a GNN, and a third operation of encoding third feature information associated with a time-series feature of the road graph from a series of the second feature information using a third encoder based on a recurrent neural network, and the road graph includes at least one node, each node corresponding to a point on a road, and at least one edge, each edge corresponding to a connection relationship between nodes.

Other aspects, features, and advantages other than those described above will become apparent from the following drawings, claims, and detailed description of the invention.

### BRIEF DESCRIPTION OF DRAWINGS

The above and other objects, features and other advantages of the present invention will be more clearly understood from the following detailed description taken in conjunction with the accompanying drawings, in which:

FIG. 1 is a diagram for describing a schematic operation of an autonomous driving control apparatus based on a Road-GNN according to an embodiment;

FIG. 2 is a block diagram of the autonomous driving control apparatus according to an embodiment;

FIG. 3 is a flowchart of an autonomous driving control method according to an embodiment;

FIG. 4 is a diagram for describing the Road-GNN according to an embodiment; and

FIG. 5 is a diagram for describing a learning process of the Road-GNN according to an embodiment.

### DETAILED DESCRIPTION

Hereinafter, the present invention will be described in more detail with reference to the drawings. The present invention may be embodied in various different forms, and is not limited to the embodiments described herein. In the following embodiments, parts not directly related to the description are omitted in order to clearly describe the present invention. However, in implementing the apparatus or system to which the idea of the present invention is applied, this does not mean that the omitted configuration is unnecessary. In addition, the same reference numerals are used throughout the specification to refer to the same or similar components.

Terms such as first, second, etc. may be used to describe various components. However, the components should not be limited by the terms. The above terms are used only for the purpose of distinguishing one component from another. In addition, in the following description, a singular expression includes a plural expression unless the context clearly dictates otherwise.

In the following description, it should be understood that a term such as “include” or “have” is intended to designate that a feature, number, step, operation, component, part, or a combination thereof described in the specification is present, and does preclude the possibility of the presence or addition of one or more other features, numbers, steps, operations, components, parts, or combinations thereof.

Hereinafter, the present invention will be described in detail with reference to the drawings.

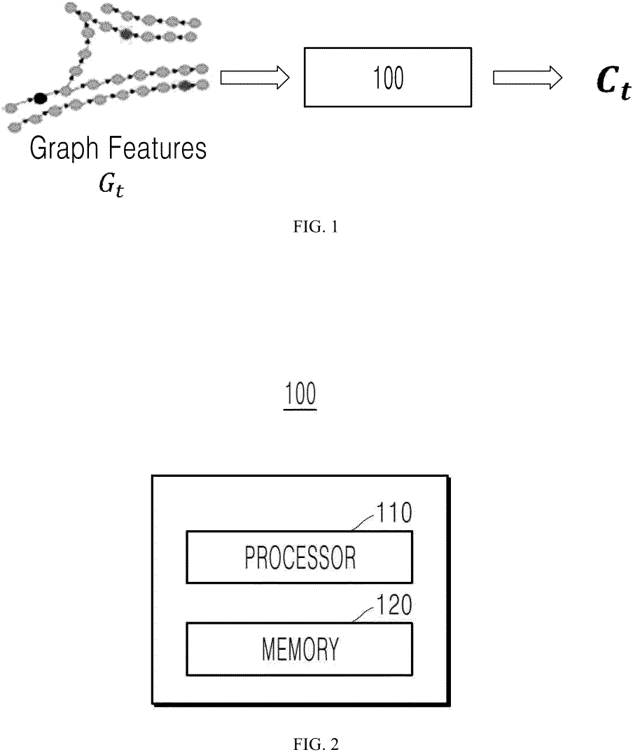

FIG. 1 is a diagram for describing a schematic operation of an autonomous driving control apparatus based on a Road-GNN according to an embodiment.

The Road-GNN is a network that calculates a high-level control value (for example, a speed at which a vehicle travels, etc.) of an autonomous vehicle using a road graph (a shape of a road is expressed using dots and lines).

The present invention proposes a Road-GNN and provides a method and apparatus for autonomous driving control using the Road-GNN.

An autonomous driving control apparatus 100 according to the embodiment outputs control information for an autonomous vehicle using the Road-GNN. That is, the autonomous driving control apparatus 100 executes the Road-GNN with an input of a road graph Gt for a given road at a time t, and as a result, outputs control information Ct for the autonomous vehicle located on the given road at the corresponding time t.

FIG. 2 is a block diagram of the autonomous driving control apparatus according to an embodiment.

The autonomous driving control apparatus 100 includes a processor 110 and a memory 120.

The processor 110 is a type of central processing unit, and may control an operation of the autonomous driving control apparatus 100 by executing one or more instructions stored in the memory 120.

The processor 110 may include any type of device capable of processing data. For example, the processor 110 may refer to a data processing device embedded in hardware having a physically structured circuit to perform a function expressed as code or an instruction included in a program.

As an example of the data processing device embedded in the hardware as described above, it is possible to include all processing devices such as a microprocessor, a central processing unit (CPU), a processor core, a multiprocessor, an application-specific integrated circuit (ASIC), and a field programmable gate array (FPGA). However, the present invention is not limited thereto. The processor 110 may include one or more processors.

The memory 120 may store at least one instruction for autonomous driving control and the Road-GNN including a first encoder, a second encoder, and a third encoder.

The memory 120 may store a program including at least one instruction for autonomous driving control according to an embodiment. The processor 110 may execute an autonomous driving control process according to an embodiment based on a program and commands stored in the memory 120.

The memory 120 may store the Road-GNN, and a parameter, input data, intermediate data, and output data for execution of the Road-GNN.

The memory 120 may include an internal memory and/or an external memory, and may include a volatile memory such as a DRAM, an SRAM, or an SDRAM, a nonvolatile memory such as one time programmable ROM (OTPROM), a PROM, an EPROM, an EEPROM, a mask ROM, a flash ROM, a NAND flash memory, or a NOR flash memory, a flash drive such as a solid state drive (SSD), a compact flash (CF) card, an SD card, a Micro-SD card, a Mini-SD card, an xD card, or a memory stick, or a storage device such as a hard disk drive (HDD). The memory 120 may include magnetic storage media or flash storage media. However, the present invention is not limited thereto.

The autonomous driving control apparatus 100 according to the embodiment may further include a communication unit (not illustrated).

The communication unit includes a communication interface for transmitting and receiving data of the autonomous driving control apparatus 100. The communication unit may connect the autonomous driving control apparatus 100 to a network 300 by providing various types of wired/wireless communication paths to the autonomous driving control apparatus 100. For example, the communication unit may include at least one of various wireless Internet modules, a short-range communication module, a GPS module, a modem for mobile communication, etc.

When at least one instruction stored in the memory 120 is executed by the processor 110, the at least one instruction may cause the processor 110 to perform a first operation of encoding first feature information associated with a node-edge-level feature of a road graph from node feature information and edge feature information of the road graph using the first encoder based on a multilayer perceptron, a second operation of encoding second feature information associated with a graph-level feature of the road graph from the first feature information using the second encoder based on a GNN, and a third operation of encoding third feature information associated with a time-series feature of the road graph from a series of second feature information using the third encoder based on a recurrent neural network.

Here, the road graph may include at least one node, each node corresponding to a point on the road, and at least one edge, each edge corresponding to a connection relationship between nodes. For example, the road graph is a directed graph.

When at least one instruction stored in the memory 120 is executed by the processor 110, the at least one instruction may cause the processor 110 to generate node feature information based on a positional relationship between a vehicle on the road and a node of the road graph, and generate edge feature information according to a driving direction on the road.

In an example, the node feature information may include location information of a node, relative location information between a node and a vehicle, and information about whether a node is a node closest to the vehicle.

In an example, the first operation may include an operation of executing the first encoder to encode node-level feature information from node feature information of each node on the road graph, executing the first encoder to encode edge-level feature information from edge feature information of each edge on the road graph, and outputting the first feature information based on the node-level feature information and the edge-level feature information.

In an example, the second operation may include an operation of executing the second encoder a predetermined number of times to output the second feature information from the first feature information.

In an example, the third operation may include an operation of executing the third encoder at predetermined time intervals to output the third feature information associated with the time-series feature of the road graph that changes according to movement of the vehicle on the road over time from the series of second feature information.

When at least one instruction stored in the memory 120 is executed by the processor 110, the at least one instruction may cause the processor 110 to execute a fourth operation of outputting control information of the vehicle mapped to the road graph from the third feature information using a reinforcement learning model.

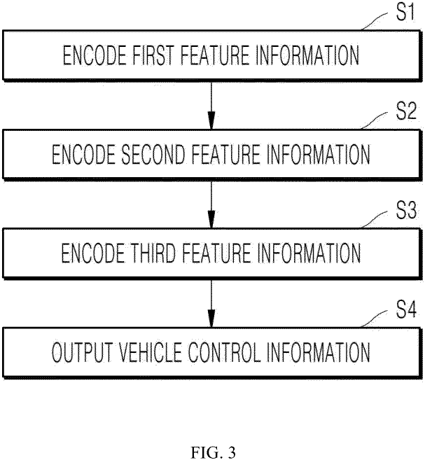

FIG. 3 is a flowchart of an autonomous driving control method according to an embodiment.

In an embodiment, the processor 110 trains a Road-GNN using driving environment data based on a road graph, and controls the autonomous vehicle using the trained Road-GNN.

Specifically, the road graph is defined by including points on the road where the vehicle can move as nodes, and including at least one edge between nodes according to the driving direction.

In the road graph, a node and an edge store node feature information and edge feature information, which are feature vectors, respectively. The node feature vector includes information such as, for example, a relative position and speed of the vehicle.

The autonomous driving control method according to the embodiment provides autonomous driving control information for the vehicle in a driving environment indicated by a given road graph.

The given road graph is subjected to a node-and-edge level encoding process (step S1 to be described later).

Node and edge level encoding information is subjected to a graph-level encoding process through a GNN (step S2 to be described later).

Thereafter, a final feature vector is calculated through time-level encoding (step S3 to be described later).

The final feature vector is input to a policy network (actor network), and the policy network calculates control information (for example, a speed control value) required for a current vehicle (step S4 to be described later).

The calculated vehicle control information is used to control an actual vehicle.

When the above description is reviewed, the autonomous driving control method performed by the autonomous driving control apparatus 100 including the processor 110 includes a first step of encoding the first feature information associated with the node-edge-level feature of the road graph from the node feature information and the edge feature information of the road graph using the first encoder based on a multilayer perceptron (step S1), a second step of encoding the second feature information associated with the graph-level feature of the road graph from the first feature information using the second encoder based on the GNN (step S2), and a third step of encoding the third feature information associated with the time-series feature of the road graph from the series of second feature information using the third encoder based on the recurrent neural network (step S3), and the road graph includes a node corresponding to a point on the road and an edge corresponding to a connection relationship between nodes.

The processor 110 may further include a preprocessing step for the graph feature information (Gt with reference to FIG. 1) before step S1.

The preprocessing step may include a step of generating node feature information based on a positional relationship between the vehicle on the road and a node of the road graph, and a step of generating edge feature information according to a driving direction on the road.

In an example, the node feature information may include location information of a node, relative location information between a node and a vehicle, and information about whether a node is a node closest to the vehicle.

In step S1, the processor 110 may encode the first feature information associated with the node-edge-level feature of the road graph from the node feature information and the edge feature information of the road graph using the first encoder based on a multilayer perceptron (first step).

Step S1 may include a step of encoding, by the processor 110, the node-level feature information from the node feature information of each node on the road graph by executing the first encoder, a step of encoding the edge-level feature information from the edge feature information of each edge on the road graph by executing the first encoder, and a step of outputting the first feature information based on the node-level feature information and the edge-level feature information.

In step S2, the processor 110 may encode the second feature information associated with the graph-level feature of the road graph from the first feature information using the second encoder based on the GNN (second step).

Step S2 may include a step of outputting the second feature information from the first feature information by executing the second encoder a predetermined number of times.

Here, the predetermined number of times is a parameter for a distance of a neighboring node to be reflected in the second feature information associated with the graph-level feature. For example, when the predetermined number of times is three, feature information of a neighboring node that can be reached from each node through three or fewer edges may be reflected in the second feature information.

In step S3, the processor 110 may encode the third feature information associated with the time-series feature of the road graph from the series of second feature information using the third encoder based on the recurrent neural network (third step).

Step S3 may include a step of executing the third encoder at predetermined time intervals to output the third feature information associated with the time-series feature of the road graph that changes according to movement of the vehicle on the road over time from the series of second feature information.

Meanwhile, the autonomous driving control method according to the embodiment may further include a fourth step of outputting control information of the vehicle mapped to the road graph from the third feature information by reinforcement learning for the policy network (step S4).

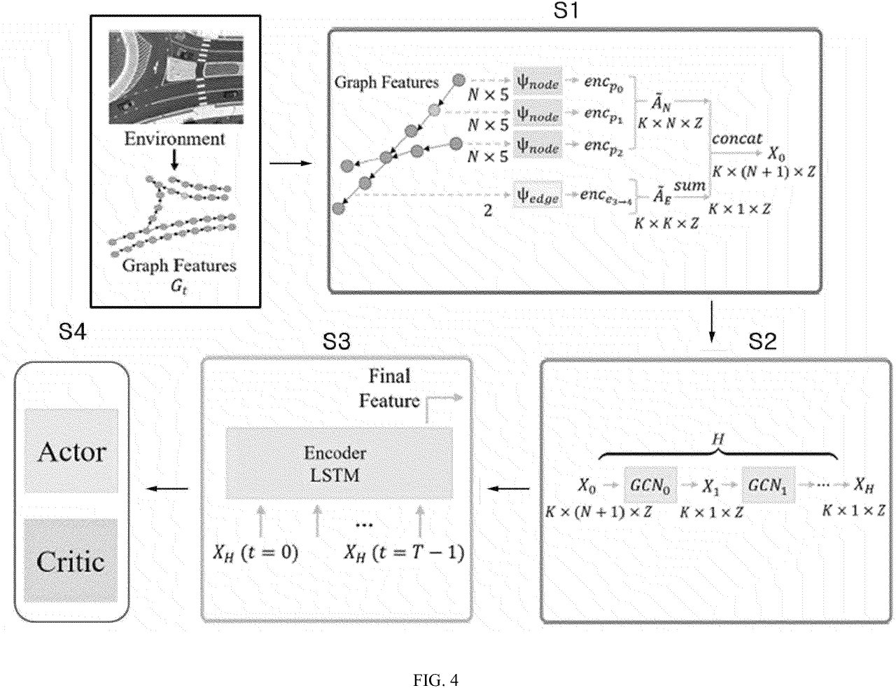

Hereinafter, autonomous driving control based on the Road-GNN according to an embodiment will be described in more detail with reference to FIG. 4.

FIG. 4 is a diagram for describing the Road-GNN according to an embodiment.

The autonomous driving control using the road graph according to the embodiment may be largely performed in three steps.

The first step is preprocessing for obtaining graph feature information (graph feature Gt) by graphing the road in advance, the second step is high-level control for inputting the graph feature information Gt to the Road-GNN to obtain control information (for example, a required speed at which the vehicle needs to travel, etc.), and the final step is low-level control for performing actual control based on the obtained control information.

### 1. Preprocessing

In preprocessing, information about the road is expressed in the form of a graph. A two-dimensional road map M in bird’s-eye view may be represented by a graph G_p.

G_p includes several points p, which mean several places on the road where the vehicle can be located. In the graph, there is an edge e that connects these points. Connection of the edge e is determined according to a direction of the road. When the vehicle can move in a direction from a point p_i to a point p_j, p_i and p_j are connected by an edge i->j in the graph G_p.

All points p and edges e have node feature information (point feature) and edge feature information (edge feature), respectively.

The node feature information (node feature) is determined by a correlation with a surrounding vehicle. For example, assuming that a total of N vehicles is present in a driving environment, one point has five features for each of the N vehicles. That is, each point has N × 5 features, and when the total number of points is K, the number of pieces of node feature information (point feature) in the total graph is k × N × 5.

Here, five features of a point for each vehicle are determined as follows. First, it is necessary to determine whether or not the point is a point closest to the vehicle. When a point closest to a vehicle v_k is not p_i, p_i has, as a feature, a zero vector having only a value 0 for v_k. On the other hand, when the point closest to v_k is p_i, p_i has a proper feature for v_k.

For example, in the node feature information, first two features are relative distances (distances in 2d coordinates) between the corresponding node and the vehicle, next two features are speeds (speeds in 2d coordinates) of the vehicle, and one last feature has a value of 1, meaning a point closest to v_k.

The edge feature information (edge feature) is determined by a direction vector of an edge. For example, edge feature information of edge i ->j becomes a 2d direction vector between point p_i and point p_j.

The edge feature information may be determined by the number of nodes K in the graph regardless of the number of vehicles. When the number of nodes is K, the total number of edges is possible up to K × K, and thus the number of possible pieces of edge feature information becomes K × K × 2. Meanwhile, for convenience of calculation, when there is no edge, calculation may be performed by treating two direction vector components as 0. Accordingly, in a later calculation, the number of pieces of edge feature information may be fixed to K × K × 2.

In preprocessing, it is possible to calculate a path on which the vehicle needs to additionally move. A path from a starting position to an arrival position may be calculated using a graph path search algorithm (for example, Dijkstra algorithm). The vehicle travels along a pre-calculated path.

### 2. Road-RNN Processing

The Road-GNN encodes a graph feature through a total of three steps of encoding processing. The encoded graph feature is input to an actor network and a critic network. The actor network calculates autonomous driving control information, thereby controlling the vehicle.

### 2.1 First Step (Node-and-Edge-Level Encoding)

The first step (step S1 with reference to FIG. 3) is node-and-edge-level encoding. The node feature information and the edge feature information previously calculated in preprocessing are encoded through the first encoder based on a multilayer perceptron network.

A total of K × N × 5 pieces of node feature information is encoded into a node feature matrix A_N having a size of K × N × Z using a node encoder in the first encoder. K × K × 5 pieces of edge feature information are encoded into an edge feature matrix A_E having a size of K × K × Z through an edge encoder in the first encoder. Here, Z is a predetermined constant.

Thereafter, in order to consider both the node feature information and the edge feature information, a process of concatenating and merging A_N and A_E is performed. Here, the size K × N × Z of A_N and the size K × K × Z of A_E have a large difference, and thus it is possible to perform a process of merging A_E into a matrix having a size of K × 1 × Z through summation.

Finally, a feature matrix X_0 is derived by concatenating the merged A_E and A_N. Here, X_0 has a size of K × (N + 1) × Z.

### 2.2 Second Step (Graph-Level Encoding)

In the second step (S2 with reference to FIG. 3), X_0 encoded in the first step S1 is re-encoded using a graph convolutional network (GCN). The GCN is a type of GNN, and updates node feature information of the graph each time the network is passed through.

When the node feature information is updated in the second step (S2), node feature information of a neighboring concatenated node is used, and a correlation between nodes is calculated accordingly.

Due to a calculation time problem, it is possible to perform a process of summating X_0 first and then adjusting the size. In this case, X_0 may be changed to a size of X × 1 × Z.

X_0 is repeatedly passed through one GCN network a predetermined number of times (H times), and a result value X_H is finally output accordingly.

### 2.3 Third Step (Time-Level Encoding)

The road graph is not fixed, and a feature of the road graph changes according to movement of vehicles. Therefore, a value of X_H varies for each time.

In this way, a long short-term memory (LSTM) network may be used to collect and encode X_Hs that change for each time.

For example, for a time t, the graph feature X_H from t = 0 to t = T - 1 is passed through an LSTM in chronological order. Here, T is a length of time interval detected at one time, which corresponds to a period. As a result of passing through the LSTM, final feature information is obtained.

### 3.2.4 Fourth Step (Actor-Critic Method) and Low-Level Controller

In the fourth step (S4 with reference to FIG. 3), the final feature information is input to the actor network and the critic network. The actor network and the critic network are trained through reinforcement learning. For example, proximal policy optimization (PPO) may be used for reinforcement learning.

The trained actor network calculates control information of the vehicle (for example, a required speed of the vehicle). A low-level controller actually controls the vehicle to follow the control information calculated in this way. Values that are substantially controllable in the vehicle are, for example, steering, braking, and acceleration. The low-level controller controls the vehicle so that the vehicle moves according to the required speed calculated by the actor network.

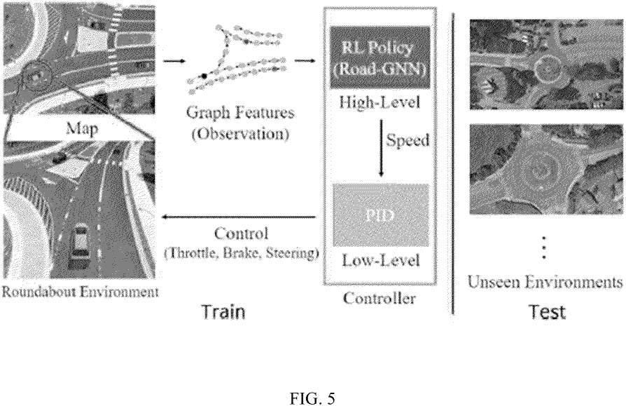

FIG. 5 is a diagram for describing a learning process of the Road-GNN according to an embodiment.

In an embodiment, a network is trained using road graph-based data, and the vehicle is controlled using the trained network. As described above, the given road graph is input to a high-level controller based on the Road-GNN.

For training of the Road-GNN, for example, a proximal policy optimization (J. Schulman, et al., “Proximal policy optimization algorithms”, arXiv preprint, 2017.) method, which is a type of reinforcement learning method, may be used. However, the present invention is not limited thereto.

Using the input information, the high-level controller calculates control information, for example speed information. Using the calculated speed information, for example, the low-level controller may calculate control values of the actual vehicle through PID control, and control the actual vehicle using the calculated control values of the vehicle.

The Road-GNN is trained using a reinforcement learning method. Various methods can be applied to network training. For example, proximal policy optimization, which is a type of actor-critic method, may be used. However, the present invention is not limited thereto.

In the actor-critic method, a total of two networks, an actor network (or policy network) and a critic network (or value network), is used. The policy network receives an input of an observation value for a surrounding environment, and outputs a necessary control value accordingly. The value network receives an input of an observation value, and outputs a value referred to as “value” for determining whether or not a current state is a favorable state as an output value.

A network is trained using the following method. A controller first acts once using a current policy network. Then, depending on the action, a reward predetermined by a person is received. After the controller completes the action, a value of “value” is immediately obtained by calculating a sum of reward values received from the beginning to the end. When the value network is trained, the calculated value of “value” is used as ground-truth data, and the network is updated so that the same value of “value” can be output, thereby performing training.

Similarly, when the policy network is trained, training is performed using the value of “value” obtained above. Whether or not a value of control performed by the policy network so far is a favorable value may be calculated using the value of “value”, and the actor network may be updated using this value. A method of updating the policy network by calculating whether or not the control value is a favorable value is referred to as policy optimization.

There are several different methods of policy optimization, one of which is proximal policy optimization. In the existing policy optimization method, there is a method referred to as a policy gradient method, and proximal policy optimization is a modified version of this method.

When the policy network is trained, if the policy network is excessively largely changed and updated, a training process may become unstable, and training may be improperly performed. Proximal policy optimization clips an updated value so that the policy network does not undergo excessively large change.

The method according to the embodiment of the present invention described above may be implemented as computer-readable code on a non-transitory recording medium in which a program is recorded. The computer-readable non-transitory recording medium includes all types of recording devices in which data readable by a computer system is stored. Examples of the computer-readable non-transitory recording medium include an HDD, an SSD, a silicon disk drive (SDD), a ROM, a RAM, a CD-ROM, a magnetic tape, a floppy disk, an optical data storage device, etc.

According to an embodiment, safe and efficient autonomous driving control is possible using a graph-based neural network and reinforcement learning.

According to an embodiment, by using road graph-based data, a network can more accurately and efficiently understand road shape information, and driving performance is improved.

Effects of the present invention are not limited to those mentioned above, and other effects not mentioned herein will be clearly understood by those skilled in the art from the above description.

The above description of the embodiments of the present invention is for illustration, and it should be understood that those of ordinary skill in the art to which the present invention pertains may easily perform modification into other specific forms without changing the technical spirit or essential features of the present invention. Therefore, it should be understood that the embodiments described above are illustrative in all respects and not restrictive. For example, each component described as a single type may be implemented in a dispersed form and, likewise, components described as distributed may be implemented in a combined form.

The scope of the present invention is indicated by the following claims rather than the above detailed description, and all changes or modifications derived from the meaning and scope of the claims and equivalents thereto should be construed as being included in the scope of the present invention.

### STATEMENT REGARDING GOVERNMENT SUPPORT

This invention was supported at least in part by Ministry of Science and ICT (MSIT) of South Korean government for research project, the title of which is “Robot Learning: Efficient, Safe, and Socially-Acceptable Machin Learning″(Project Number: 1711125970) managed by Institute of Information & Communications Technology Planning & Evaluation (IITP).

What is claimed is:

1. An autonomous driving control method performed by an autonomous driving control apparatus including a processor, the autonomous driving control method comprising:
encoding first feature information associated with a node-edge-level feature of a road graph from node feature information and edge feature information of the road graph using a first encoder based on a multilayer perceptron;
encoding second feature information associated with a graph-level feature of the road graph from the first feature information using a second encoder based on a graph neural network (GNN); and
encoding third feature information associated with a time-series feature of the road graph from a series of the second feature information using a third encoder based on a recurrent neural network,
wherein the road graph includes at least one node, each node corresponding to a point on a road, and at least one edge, each edge corresponding to a connection relationship between nodes.

2. The autonomous driving control method according to claim 1, further comprising:
generating the node feature information based on a positional relationship between a vehicle on the road and a node of the road graph; and
generating the edge feature information according to a driving direction of the road.

3. The autonomous driving control method according to claim 1, wherein the node feature information includes information about a relative position between a node and a vehicle, speed information of the vehicle, and information about whether a node is a node closest to the vehicle.

4. The autonomous driving control method according to claim 1, wherein the encoding of the first feature information includes:
encoding node-level feature information from node feature information of each node of the road graph by executing the first encoder;
encoding edge-level feature information from edge feature information of each edge of the road graph by executing the first encoder; and
outputting the first feature information based on the node-level feature information and the edge-level feature information.

5. The autonomous driving control method according to claim 1, wherein the encoding of the second feature information includes executing the second encoder a predetermined number of times to output the second feature information from the first feature information.

6. The autonomous driving control method according to claim 1, wherein the encoding of the third feature information includes executing the third encoder at predetermined time intervals to output the third feature information associated with a time-series feature of the road graph changing according to movement of a vehicle on the road over time from a series of the second feature information.

7. The autonomous driving control method according to claim 1, further comprising outputting control information of a vehicle mapped to the road graph from the third feature information by reinforcement learning for a policy network.

8. An autonomous driving control apparatus comprising:
a processor; and
a memory configured to store a road graphical neural network (Road-GNN) including a first encoder, a second encoder, and a third encoder, and at least one instruction,
wherein, when executed by the processor, the at least one instruction is configured to cause the processor to perform:
a first operation of encoding first feature information associated with a node-edge-level feature of a road graph from node feature information and edge feature information of the road graph using the first encoder based on a multilayer perceptron;
a second operation of encoding second feature information associated with a graph-level feature of the road graph from the first feature information using the second encoder based on a GNN; and
a third operation of encoding third feature information associated with a time-series feature of the road graph from a series of the second feature information using a third encoder based on a recurrent neural network, and
the road graph includes at least one node, each node corresponding to a point on a road, and at least one edge, each edge corresponding to a connection relationship between nodes.

9. The autonomous driving control apparatus according to claim 8, wherein, when executed by the processor, the at least one instruction is configured to cause the processor to:
generate the node feature information based on a positional relationship between a vehicle on the road and a node of the road graph; and
generate the edge feature information according to a driving direction of the road.

10. The autonomous driving control apparatus according to claim 8, wherein the node feature information includes information about a relative position between a node and a vehicle, speed information of the vehicle, and information about whether a node is a node closest to the vehicle.

11. The autonomous driving control apparatus according to claim 8, wherein the first operation includes operations of:
encoding node-level feature information from node feature information of each node of the road graph by executing the first encoder;
encoding edge-level feature information from edge feature information of each edge of the road graph by executing the first encoder; and
outputting the first feature information based on the node-level feature information and the edge-level feature information.

12. The autonomous driving control apparatus according to claim 8, wherein the second operation includes an operation of executing the second encoder a predetermined number of times to output the second feature information from the first feature information.

13. The autonomous driving control apparatus according to claim 8, wherein the third operation includes an operation of executing the third encoder at predetermined time intervals to output the third feature information associated with a time-series feature of the road graph changing according to movement of a vehicle on the road over time from a series of the second feature information.

14. The autonomous driving control apparatus according to claim 8, wherein, when executed by the processor, the at least one instruction is configured to cause the processor to perform a fourth operation of outputting control information of a vehicle mapped to the road graph from the third feature information by reinforcement learning for a policy network.

15. A computer-readable non-transitory recording medium storing a computer program including at least one instruction for executing, by a processor, the autonomous driving control method comprising:
encoding first feature information associated with a node-edge-level feature of a road graph from node feature information and edge feature information of the road graph using a first encoder based on a multilayer perceptron;
encoding second feature information associated with a graph-level feature of the road graph from the first feature information using a second encoder based on a graph neural network (GNN); and
encoding third feature information associated with a time-series feature of the road graph from a series of the second feature information using a third encoder based on a recurrent neural network,
wherein the road graph includes at least one node, each node corresponding to a point on a road, and at least one edge, each edge corresponding to a connection relationship between nodes.
